(19) United States
(12) Patent Application Publication
(10) Pub. No.: US 2010/0224561 A1
(43) Pub. Date: Sep. 9, 2010

(54) PROCESS FOR MINIMIZING PRODUCED WATER BRINES USING FORWARD OSMOSIS

(76) Inventor: Mark A. Marcin, Golden, CO (US)

Correspondence Address: Woodard, Emhardt, Moriarty, McNett & Henry LLP, 111 Monument Circle, Suite 3700, Indianapolis, IN, 46204-5137, US

(21) Appl. No.: 12/703,483

(22) Filed: Feb. 10, 2010

Related U.S. Application Data
(60) Provisional application No. 61/151,448, filed on Feb. 10, 2009.

(51) Int. Cl. B01D 61/24; B01D 61/28

(52) U.S. Cl. 210/644; 210/209

(57) ABSTRACT

A method and system for water treatment is described according to embodiments. In an embodiment, a lower volume concentrated solution, and a beneficial diluted draw solution are produced, which may be marketed.

### RELATED APPLICATION DATA

This application claims the benefit of U.S. Provisional App. No. 61/151,448 filed Feb. 10, 2009, the disclosure of which is incorporated by reference.

### BACKGROUND

Aspects of this disclosure are related, in general, to the field of water treatment and, more specifically, to the field of generally minimizing the waste generated during the treatment of produced water and creating a beneficial diluted draw solution and other uses.

Salt rejecting membranes have been used successfully for reverse osmosis (RO) applications for more then 40 years. In this process a concentrated, high total dissolved solids (TDS) solution with a high osmotic pressure may be forced to dewater across a semi-permeable membrane by applying a pressure greater then the osmotic pressure of the high TDS solution. This net driving force may be supplied by pump pressure of the high TDS feed solution. A concentrated brine may be formed containing almost all the dissolved solids existing in the feed solution. The commercialization of reverse osmosis may be limited by the necessary disposal of the concentrated brine. Attempts to reduce the brine volume by further concentration may have drawbacks including high operating costs using technologies such as evaporation/distillation or a secondary reverse osmosis (RO) treatment of the brine.

### SUMMARY

Forward osmosis systems may allow further concentrating of the brine (or a solution to be concentrated) or untreated produced water by passing the brine/produced water on one side of a forward osmosis membrane (such as a semi-permeable membrane) and on the other side of the membrane, a draw solution with a much greater osmotic pressure then the solution to be concentrated.

Systems and methods disclosed herein may include a process for the beneficial use of a diluted draw solution produced as a by-product of the treatment of produced water, treatment of produced water brine from reverse osmosis, or another solution to be concentrated. The beneficial use products may be in the form of a dust control agent, deicing solution, hydraulic fracturing, or a liquid fertilizer, and/or other applications. One embodiment of the forward osmosis system may include the use of a semi-permeable membrane with a salt rejection of greater then 99% and a flux of 12-22 gfd. In an embodiment, the forward osmosis membranes may be comprised of standard RO membranes, cellulose acetate or polytetrafluorethylene membranes with hydrophobic characteristics.

The process may be accomplished by passing a solution to be generally concentrated, such as produced water or concentrated brines from oil & gas exploration on one side of a semi-permeable membrane, and on the other side a concentrated draw solution whose osmotic pressure is greater than that of the solution to be concentrated. This will cause water to flow across said membrane from the produced water solution to the draw solution until equilibrium is approached. The driving force for this transfer of water is based at least in part on the osmotic pressure differential between the two solutions.

The solution to be concentrated may passively dewater, creating a lower volume concentrated solution, which may be concentrated by a factor as high as 70%, and diluting the draw solution in generally equal proportions. No additional energy may be required to accomplish this dewatering other then the pumping energy necessary to move the solutions through the membrane stacks (less then 40 psi). In other methods, draw solutions containing recoverable components are used. To recover these solutions requires additional capital and energy although work continues to improve the efficiency of those methods. In these situations, highly concentrated brine is produced as well as high purity water and a concentrated draw solution, which can be reused in the process of preparing the draw solution.

In the present disclosure, the dilute draw solution does not undergo additional treatment but is removed offsite for beneficial use as a road dust control or deicing agent, hydraulic fracturing or as an agricultural animal feed or fertilizer source. This may eliminate further processing cost, as well as creating a marketable by-product.

The benefits of this low energy approach may include the ability to treat high fouling oil & gas produced water as well as those produced waters with high TDS such as RO brines. The draw solutions can be highly soluble, low molecular weight solutions of magnesium, or calcium chloride, sodium or potassium chloride, potassium nitrate, ammonium nitrate, sodium di-hydrogen phosphate, as well as concentrated solutions of urea, among other solutions. The diluted draw solutions become a marketable product upon dilution during the forward osmosis process and can be marketed locally to the point of origin. Further benefits may include reducing the amount of concentrated brine solution, which may reduce the cost of disposal.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiments disclosed herein. On the contrary, the intent is to cover all alternatives, modifications, and equivalents.

FIG. 1 is a block diagram of a system according to an embodiment for water treatment.

FIG. 2 is a flow diagram of a method according to an embodiment for water treatment.

### DETAILED DESCRIPTION

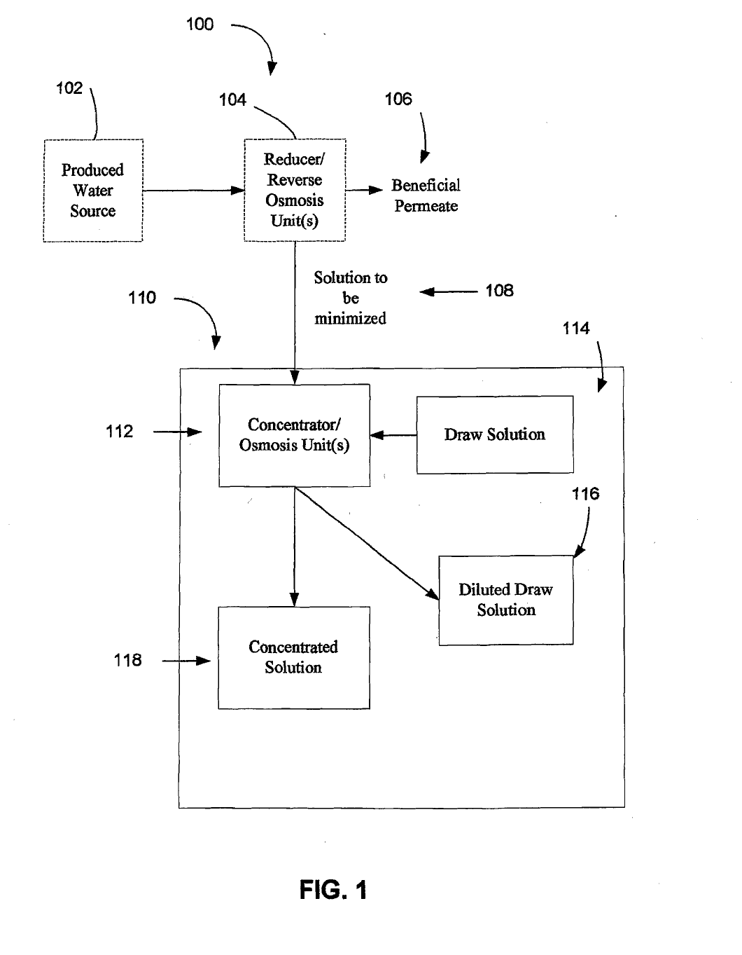

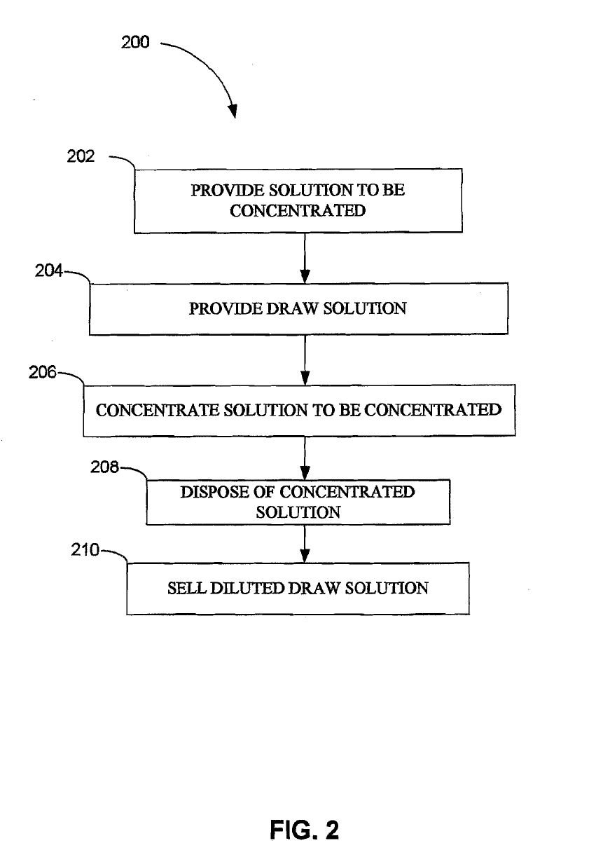

FIGS. 1-2 and the following description depict embodiments to teach those skilled in the art how to make and use the embodiments. For the purpose of teaching principles, some conventional aspects have been simplified or omitted. Those skilled in the art will appreciate variations from these embodiments that fall within the scope of the disclosure. Those skilled in the art will also appreciate that the features described below can be combined in various ways to form multiple embodiments. As a result, the disclosure is not limited to the specific embodiments described below, but only by the claims and their equivalents.

FIG. 1 is a block diagram of a system 100 capable of water treatment, according to embodiments. The system 100 optionally includes a produced water source 102, and a treatment process 104. Produced water source 102 may be providing produced waters from the oil and gas industry. It will be appreciated that the source of the produced water may be from anywhere that a solution is generated.

Treatment process 104 may include a reverse osmosis system, which may be capable of providing a produced water to be concentrated 108 and a beneficial permeate 106. It will be appreciated that other embodiments may be utilized for the treatment process 104. The produced water to be concentrated 108 may include varying concentrations of brine, raw untreated produced water as well as other solutions, which may be concentrated.

System 100 may also include a waste concentrating system 110. Waste concentrating systems 110 may be capable of minimizing the solution to be concentrated 108 as well as creating a diluted draw solution 116. Waste concentration systems 110 may include a waste concentrator 112. The waste concentrator 112 may be capable of receiving the solution to be concentrated 108, as well as being capable of receiving draw solution 114. Waste concentrator 112 may be capable of outputting concentrated brine solution 118 and diluted draw solution 116.

The solution to be concentrated 108, typically brine generated from the reverse osmosis 104 treatment of produced water or untreated high TDS produced water 102, may be pumped across the waste concentrator 112. In an embodiment, waste concentrator 112 may include a forward osmosis (FO) membrane, which can be a standard reverse osmosis membrane, a cellulose acetate membrane, or one composed of polytetrafluoroethylene, or other membrane that is hydrophobic in nature. This membrane can be a spiral wound membrane or a flat sheet and should maintain a flux of 12-22 gfd (gallons per square foot per day) which may reduce capital costs.

On the other side of the FO membrane a draw solution 114 may be pumped. Draw solution 114 may be a solution with a much greater osmotic pressure than the solution to be concentrated 108. Draw solution 114 may contain highly soluble ionic compounds such as highly soluble, low molecular weight solutions of magnesium chloride, calcium chloride, sodium chloride, potassium chloride, potassium nitrate, ammonium nitrate, sodium di-hydrogen phosphate, as well as concentrated solutions of urea, and/or other compounds, and/or combinations thereof. Any draw solution may work as long as the draw solution 114 has a higher osmotic pressure then the solution to be concentrated 108, and the draw solution 114 does not damage the forward osmosis membranes, dewatering of the solution to be concentrated 108 will occur.

According to various embodiments the draw solution 114 may comprise:

a. The use of a draw solution comprising magnesium chloride at concentrations up to 32%,

b. The use of a draw solution comprising calcium chloride at concentrations up to 40%,

c. The use of a draw solution comprising potassium nitrate at a concentration up to 24%,

d. The use of a draw solution comprising urea at a concentration up to 50%,

e. The use of a draw solution comprising sodium di-hydrogen phosphate at a concentration up to 40%,

f. The use of draw solutions comprising combinations of potassium nitrate, urea and sodium di-hydrogen phosphate at varying concentrations.

g. The use of a draw solution comprising sodium chloride at concentrations up to 25%.

h. The use of a draw solution comprising potassium chloride at concentrations up to 26%.

These draw solutions 114 may exhibit an osmotic pressure as high as 560 atm (8229 psi). As water passes thru the membrane from the solution to be concentrated side to the draw solution side, the osmotic pressure of the draw solution decreases while the osmotic pressure of the feed side increases. Salt rejection of these membranes may be as high as greater than 99%, and any salt passage will most likely be in the form of sodium chloride and would not contaminate the draw solution. This continues until equilibrium is reached and dewatering ceases. The solution to be concentrated 108 may lose 20-70% of its original volume with an associated gain in the volume of draw solution 116. The diluted draw solution 116 may then be sent to storage tanks for sale in dust control, deicing or agricultural supplements, among other applications. The concentrated solution 118, approaching 250,000 mg/l, may be disposed of in an evaporation pond or deep well injection process, or other process. In addition, this concentrated solution could be a marketable product at this concentration or may be crystallized in a thermal process if the solid salt generated is a marketable product. A potential beneficial use of this concentrated brine is in the hydraulic fracturing process used in oil and gas exploration.

The diluted draw solutions 116, which include magnesium and calcium chloride, can be used for dust control on the unpaved roads used to access many of the oil & gas exploration sites located throughout the United States. These products are the current standard for dust control and are approved for that purpose. In addition, these products may be used as deicing compounds.

The diluted draw solutions 116 containing potassium nitrate, ammonium nitrate, sodium di-hydrogen phosphate, urea or combinations thereof can be used for agricultural purposes in the dairy, cattle and swine industries as well as the golf course and farming application of fertilizers. Urea can be used as an animal feed supplement.

The diluted draw solutions 116 containing sodium chloride or potassium chloride or combinations thereof can be used for oil and gas exploration drilling and well completion practices including hydraulic fracturing or other frac purposes.

The solution to be concentrated 108 may include a produced water with less than 100,000 mg/L TDS. The draw solution 114 may include a salt solution with a concentration of 250,000-500,000 mg/L TDS. The concentrated brine solution 118 may have a concentration of less than about 260,000 mg/L TDS. The diluted draw solution 116 may be of any concentration that is generally marketed for a particular purpose. The concentration of the diluted draw solution 116 may be controlled by monitoring specific gravity or any other suitable method.

FIG. 2 provides a flow diagram of a method 200 for water treatment, according to embodiments. In the method 200, a solution to be concentrated is provided (operation 202). In one embodiment, this may be accomplished by brine generated from the reverse osmosis treatment of produced water or untreated high TDS produced water is pumped in.

Method 200 may also include providing a draw solution (operation 204). This may be accomplished at least in part by dissolving a solid salt, such as magnesium chloride in a water or other solution, thereby creating a highly concentrated salt solution. The draw solution may also be pumped in.

According to embodiments, method 200 may include reducing the volume of the solution to be concentrated (operation 206). This may be accomplished at least in part using a forward osmosis system. The solution to be concentrated may be pumped across one side of the forward osmosis (FO) membrane. On the other side of the FO membrane, the draw solution may be pumped. The difference in osmotic pressure will cause the solution to be concentrated to dewater, thereby diluting the draw solution. The draw solution may be diluted down to a level, which may be suitable for the applications listed above, such that a marketable product is created.

Method 200 may include disposing of the concentrated brine solution (operation 208). This may be accomplished at least in part by disposing in an evaporation pond or deep well injection process, or other process.

According to embodiments, method 200 may include disposing of the concentrated brine solution (operation 208). This may be accomplished at least in part by using the concentrated brine, mainly sodium chloride, for well completion practices such as hydraulic fracturing. This method eliminates disposal costs.

According to embodiments, method 200 may include marketing the diluted draw solution 210. The uses of the diluted draw solution may include dust control, deicing, well hydraulic fracturing or agricultural supplements, among other applications

The solution to be concentrated may be reduced by 20-70% in volume. This may create a cost savings as the cost of disposal is based upon volume. An additional benefit of this system is creation of a marketable product in the diluted draw solution. A further benefit of this system is the low energy and lower capital cost requirement of a forward osmosis system.

While FIG. 2, as well as other flow diagrams presented herein, may indicate a particular order of execution, other orders of execution, including concurrent or simultaneous execution, may be possible while remaining within the scope of the invention.

In this detailed description, numerous specific details are set forth to provide a thorough understanding of claimed subject matter. However, it will be understood by those skilled in the art that claimed subject matter may be practiced without these specific details. In other instances, well-known methods, procedures, components and/or devices have not been described in detail.

Embodiments discussed and/or claimed may include one or more apparatuses for performing the operations herein. Such an apparatus may be specially constructed for the desired purposes, or it may comprise a general-purpose device selectively activated and/or reconfigured by a program stored in a control device.

In the description and/or claims, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of treating a solution, comprising:
providing a solution to be concentrated;
providing a draw solution;
generally minimizing the solution to be concentrated to create a reduced volume concentrated brine solution and a diluted draw solution;
disposing of the concentrated brine solution; and
marketing the diluted draw solution.

2. The method according to claim 1, further comprising providing a produced water treatment solution.

3. The method according to claim 2, further comprising reducing the produced water volume to create the solution to be concentrated, and a permeate.

4. The method according to claim 3, wherein the draw solution comprises a generally highly soluble salt solution.

5. The method according to claim 1, wherein the solution to be concentrated comprises a solution produced by the oil and gas industry.

6. The method according to claim 1, wherein the draw solution comprises a generally highly soluble salt solution.

7. The method according to claim 1, wherein the draw solution comprises a low molecular weight solute.

8. The method according to claim 1, wherein the draw solution comprises one or more of magnesium chloride, calcium chloride, sodium chloride, potassium chloride, potassium nitrate, ammonium nitrate, sodium di-hydrogen phosphate, and urea.

9. The method according to claim 1, wherein minimizing the solution comprises utilizing an osmosis system.

10. The method according to claim 1, wherein the disposing of the concentrated brine solution comprises reinjecting the concentrated brine solution back into the ground or utilizing the concentrated brine for hydraulic fracturing purposes thereby eliminating disposal.

11. The method according to claim 1, wherein the diluted draw solution is compatible with use as dust control, deicing solution, hydraulic fracturing, fertilizer, and/or feed supplement, and/or combinations thereof.

12. A system configured to perform the method according to claim 1.

13. A system capable of treating water, comprising:
a membrane filter system configured to receive a solution to be concentrated and a draw solution; and
means for creating, primarily by osmotic forces, a concentrated brine solution for disposal and a diluted draw solution capable of being marketed.

14. The system according to claim 13, further comprising a treatment system capable of receiving a produced water and creating the solution to be concentrated and a permeate.

15. The system according to claim 13, wherein the draw solution comprises a generally highly water soluble salt solution.

16. The system according to claim 13, wherein the draw solution comprises a low molecular weight solute.

17. The system according to claim 13, wherein the draw solution comprises one or more of magnesium chloride, calcium chloride, sodium chloride, potassium chloride, potassium nitrate, ammonium nitrate, sodium di-hydrogen phosphate, and urea.

18. The system according to claim 13, wherein the treatment system comprises utilizing an osmosis system.

19. The system according to claim 13, wherein the disposing of the concentrated brine solution comprises reinjecting the concentrated brine solution back into the ground or utilizing the concentrated brine in hydraulic fracturing procedures thereby eliminating disposal.

20. The system according to claim 13, wherein the diluted draw solution is compatible with use as dust control, deicing solution, hydraulic fracturing, fertilizer, and/or feed supplement, and/or combinations thereof.
